(19) United States
(12) Patent Application Publication
(10) Pub. No.: US 2004/0264394 A1
(43) Pub. Date: Dec. 30, 2004

(54) Method and apparatus for multi-channel wireless LAN architecture

(76) Inventors: Boris Ginzburg, Haifa (IL); Vladimir Kondratiev, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/608,127

(22) Filed: Jun. 30, 2003

(51) Int. Cl. H04B 7/00

(52) U.S. Cl. 370/310

(57) ABSTRACT

Embodiments of the present invention provide a method, apparatus and system for multi-channel Basic Service Set (BSS) wireless local area network (WLAN) architecture to enable switching communication between a media access controller of an access point and a plurality of remote units between multiple channels.

### BACKGROUND OF THE INVENTION

Wireless local area networks (WLAN) may include several access points, each communicating with an association of one or more remote units. The communication between an access point (AP) and its associated remote unit or units is performed by a media access controller (MAC) over a single frequency channel, whereas other access points communicate with their associated remote units over a different channel. Some WLAN systems may employ AP units having multiple AP cards, wherein an AP card has its own media access controller. In such systems, a remote unit being reassigned from the channel of one AP card to the channel of another AP card must be disconnected from the one AP card and connected to the other AP card, requiring cutting off communication with the original AP card and resuming a new communication with the reassigned AP card, which may require re-authentication of the remote unit. This may result in a cumbersome and time-consuming reassignment procedure.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic diagram of a wireless communication system having at least two units in wireless communication using a multi-channel BSS architecture for a WLAN in accordance with an exemplary embodiment of the present invention;

FIG. 2 is a schematic illustration of a multi-channel Basic Service Set (BSS) wireless local area network (WLAN) architecture in accordance with exemplary embodiments of the present invention;

FIG. 3 is a schematic illustration of the multi-channel BSS WLAN architecture of FIG. 2, after a remote unit has been allocated to a different channel of an access point of the WLAN in accordance with exemplary embodiments of the present invention; and

FIG. 4 is a schematic block diagram of a method of operation of a multi-channel BSS architecture for a WLAN in accordance with exemplary embodiments of the present invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that the present invention may be used in a variety of applications. Although the present invention is not limited in this respect, the circuits and techniques disclosed herein may be used in many apparatuses such as units of an wired network for example, local area network (LAN) and/or wireless communication system, such as for example, a WLAN communication system and/or in any other unit and/or device in which power saving may be desirable. Units of WLAN communication system intended to be included within the scope of the present invention include, by way of example only, mobile units (MU), access points (AP), wireless receivers, and the like.

Exemplary embodiments of the invention provide a method and apparatus for multi-channel Basic Service Set (BSS) WLAN architecture. In a wireless communication system, such as for example, a wireless local area network (WLAN), including a base station and a remote unit, it may be desirable for a base station to communicate with an association of one or more remote units over multiple channels.

Types of WLAN communication systems intended to be within the scope of the present invention include, although are not limited to, “IEEE-Std 802.11, 1999 Edition (ISO/IEC 8802-11: 1999)” standard, and more particularly in “IEEE-Std 802.11b-1999 Supplement to 802.11-1999, Wireless LAN MAC and PHY specifications: Higher speed Physical Layer (PHY) extension in the 2.4 GHz band”, “IEEE-Std 802.11a-1999, Higher speed Physical Layer (PHY) extension in the 5 GHz band” standard, and the like.

Although the scope of the present invention is not limited in this respect, the circuits and techniques disclosed herein may also be used in units of a wireless communication systems, digital communication systems, satellite communication systems and the like.

Devices, systems and methods incorporating aspects of embodiments of the invention are also suitable for computer communication network applications, for example, intranet and Internet applications. Embodiments of the invention may be implemented in conjunction with hardware and/or software adapted to interact with a computer communication network, for example, a local area network (LAN), wide area network (WAN), or a global communication network, for example, the Internet.

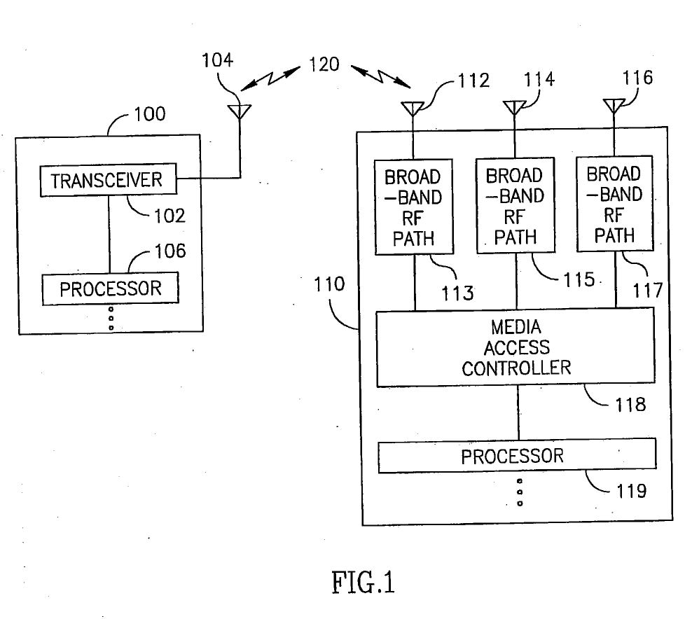

Reference is made to FIG. 1, which schematically illustrates a multi-channel BSS WLAN architecture in accordance with an embodiment of the present invention. It will be appreciated by those skilled in the art that the simplified components schematically illustrated in FIG. 1 are intended for demonstration purposes only, and that other components may be required for operation of the wireless devices. Those of skill in the art will further note that the connection between components in a wireless device need not necessarily be exactly as depicted in the schematic diagram.

FIG. 1 schematically illustrates two wireless units 100 and 110, communicating via a wireless link or channel 120 of a wireless communication system in accordance with embodiments of the present invention. Although the scope of the present invention is not limited in this respect, communication devices 100 and 110 may include wire or wireless or cable modems of computers and communication channel 120 may be part of a wide-area-network (WAN) or a LAN. For example, the system may be a WLAN system or a digital subscriber line (DSL) system.

Although the scope of the present invention is not limited in this respect, the exemplary communication system shown in FIG. 1 may be part of a wireless communication system, in which wireless device 100 is a remote unit (RU) and wireless unit 110 is an access point (AP). It will be recognized that either or both communication devices 100 and 110 may be mobile stations, a pager communication system, a personal digital assistant (PDA) and a server, or any other device or combination of devices suitable for communicating of the communication system.

Communication device 100 may include a transceiver 102, which may include a transmitter and/or a receiver in any suitable configuration. Transceiver 102 may include any suitable transmission and/or reception circuitry known in the art and may be implemented, for example, in the form of a single unit or in the form of separate transmitter and receiver units using any suitable combination of hardware and/or software as is known in the art. For example, in the context of the embodiment described with reference to FIG. 1, transceiver unit 102 may operate to both transmit and receive signals.

Communication devices 100 and 110 may include a radio frequency antenna, as is known in the art. For example, device 100 may include antenna 104 associated with transceiver 102, and device 110 may include a plurality of antennas, for example, antennas 112, 114, and 116. Any type of antenna suitable for RF transmission and/or reception, for example, dipole, omnidirectional, semi-omnidirectional, etc., may be used in conjunction with implementations of the present invention.

Wireless device 100 may include a processor 106, which may be associated with a memory (not shown). Processor 116 may communicate with transceiver 102 and may process data packets of signals received by transceiver 102 and/or data packets of signals intended for transmission by transceiver 102. Wireless device 110 may include a processor 119, which may be associated with a memory (not shown), and a media access controller (MAC) 118. According to exemplary embodiments of the present invention, MAC 118 may be connected to a plurality of broadband radio frequency (RF) paths, for example, paths 113, 115 and 117, which in turn may transmit and receive data over different channels simultaneously via antennas 112, 114, and 116, respectively. The MAC 118 may include any suitable type of controller capable of accepting data from processor 119 and sending different data streams to the appropriate broadband RF path and antenna for transmission to the intended remote unit. The processor 119 or memory (not shown) may contain a table or other data structure to keep track of which remote units are connected to the AP over which channels. This table or other data structure may be updated to reflect reassignment of remote units to new channels. The RF path/antenna pairs may correspond to the different channels on which the AP is capable of communicating with remote units.

By using the same MAC for all RF path/antenna pairs, in accordance with exemplary embodiments of the invention, as described below, unit 110 may be in substantially continual communication with a remote unit even while reassigning the remote unit from one channel to another. In connection with exemplary embodiments of the invention, it may be desirable to provide isolation between antennas of, for example, at least 60-80 dB. Any suitable RF path known in the art may be used in accordance with embodiments of the present invention.

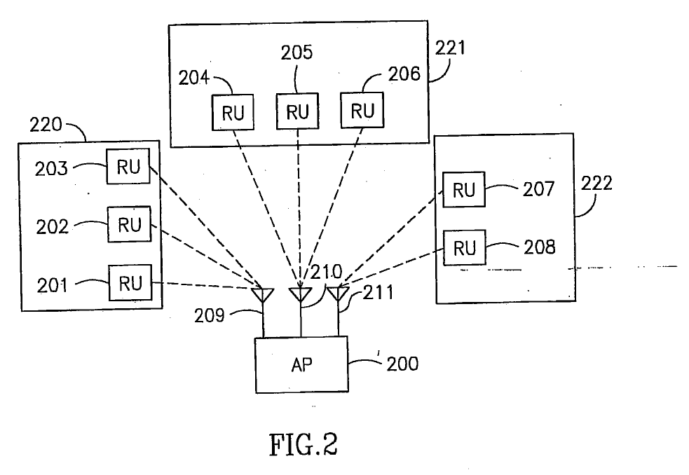

Reference is made to FIG. 2, which depicts an exemplary embodiment of the invention, in which an access point (AP) 200 communicates with a plurality of remote units, denoted 201-208. AP 200 may be capable of communicating with remote units 201-208 via a plurality of antennas, for example, three antennas 209, 210 and 211, wherein an antenna transmits and receives signals in communication with a different association of remote units over a different channel. In the illustration of the embodiment of the invention shown, a first association 220 of remote units 201, 202 and 203 may communicate with AP 200 over a first channel via antenna 209; a second association 221 of remote units 204, 205 and 206 may communicate with AP 200 over a second channel via antenna 210; and a third association 222 of remote units 207 and 208 may communicate with AP 200 over a third channel via antenna 211.

According to exemplary embodiments of the present invention, the assignment of a remote unit to a particular association of remote units in communication with the AP may be changed without the need to disconnect or otherwise disrupt communication between the AP and the remote unit being reassigned. There may be several reasons for moving a station from one channel to another, as described in detail below.

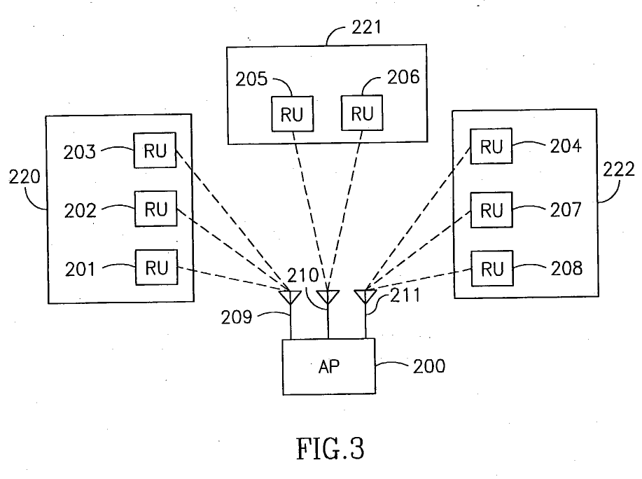

Reference is made to FIG. 3, which depicts the reassignment of a remote unit from one channel to another channel in accordance with embodiments of the present invention. As shown, remote unit 204 may be reassigned to association 222 in communication with AP 200 via antenna 211 and its associated channel, rather than with its originally assigned association 221, in communication with AP 200 via antenna 210 and its associated channel.

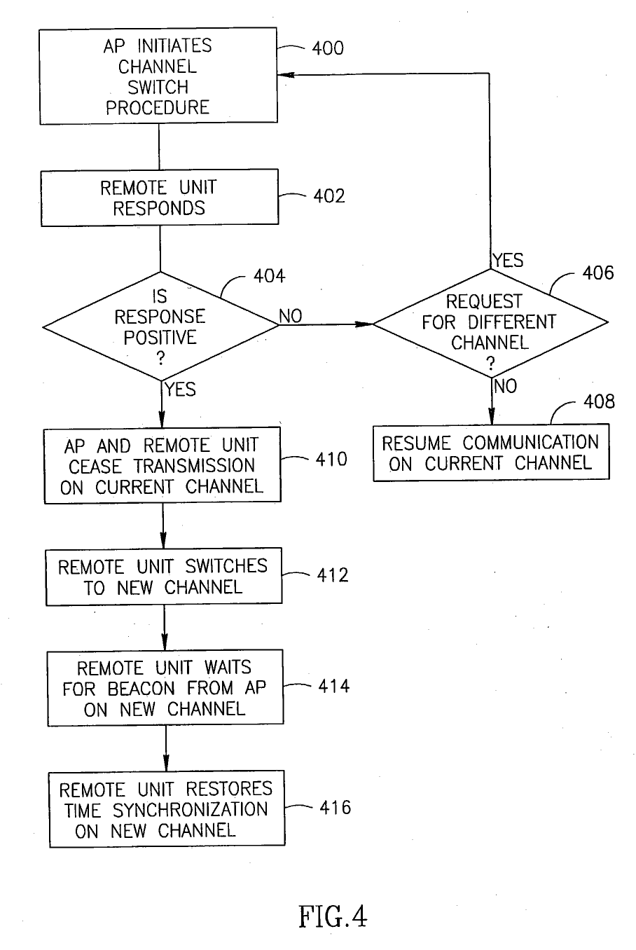

Reference is made to FIG. 4, which depicts a method of operation of a multi-channel BSS architecture for a WLAN in accordance with exemplary embodiments of the present invention. In exemplary embodiments of the invention, there may be several reasons and mechanisms for moving a remote unit from one AP to another AP. According to exemplary embodiments of the invention, a change of association may be initiated by either the AP or the remote unit. The AP may decide to switch a remote unit from its current channel to a new channel, for example, because the current channel is “noisy” with interference or because radar was detected on the channel. The AP may, for example, decide to switch a remote unit from its current channel in order to free the channel for radio measurements. The AP may also, for example, decide to switch a remote unit from its current channel in order to balance the transmission load between two or more channels, e.g., switch one or more remote units from a busy channel to a more vacant channel.

As depicted at block 400, in the event that the AP decides to switch a remote unit to a new channel, it may initiate a channel switch procedure, for example, as the one described in IEEE-Std 802.11 TGh (Dynamic Frequency Selection) Spectrum and Transmit Power Management Extensions in the 5 GHz band in Europe. In exemplary embodiments of the invention, the AP may send the remote unit a channel switch announcement in a frame containing parameters such as, for example, mode, new channel, and counter. This frame may contain a new channel number to which the AP wishes to reassign the remote unit, and a counter containing a number of remaining beacons before the channel switch event. The mode field may, for example, be a Channel Switch Mode, indicating restrictions on transmission until a channel switch is performed. For example, an AP in a BSS or a remote unit may set the Channel Switch Mode field to either 0 or 1 on transmission. A Channel Switch Mode set to 1 may indicate that the remote unit in a BSS to which the frame containing the element is addressed should not transmit any further frames within the BSS until the scheduled channel switch is performed. As depicted at block 402, the remote unit may respond to the AP's channel switch request. As depicted at block 404, if the response is negative, the remote unit may request a different channel. If so, as depicted at block 406, the AP may initiate a channel switch procedure in accordance with the remote unit's request. It will be understood that the AP may choose not to switch the remote unit to the channel it has requested, for example, for reasons of load balancing. In some exemplary embodiments of the invention, a remote unit choosing not to change channel may also choose to switch to a different BSS, if available. If the remote unit that has rejected the AP's request to change channel does not request a different channel, communication may resume on the current channel, as depicted at block 408. If the remote unit has agreed to the AP's channel change, then, as depicted at block 410, prior to the last beacon before the announced change, the AP and remote unit may cease transmission on the current channel. The remote unit may switch to the new channel (block 412), where it may await a beacon on the new channel from the AP (block 414), restore the time synchronization and return to a normal receive/transmit mode on the new channel (block 416).

Also in accordance with embodiments of the present invention, the channel of communication may be changed based upon a request from a remote unit. A remote unit may initiate a channel change for several reasons. For example, a remote unit may request reassignment to a new channel due to deterioration in communication and/or because interference is detected on the current channel, for example, interference by Bluetooth or Digital Enhanced Cordless Telecommunications (DECT) phone devices. In another example, the remote unit may request a change of channel to improve link quality per remote unit; for example, if a remote unit has moved outside a range capable of supporting a link at a given frequency, e.g., 5 GHz, the remote unit may be reassigned to communicate at a farther-reaching frequency, e.g., 2.4 GHz, where less deterioration or signal loss may be experienced. According to exemplary embodiments of the present invention, a remote unit may send to the AP a request to change channel. The AP may in response transmit a channel switch announcement, as described in connection with FIG. 4, above.

In accordance with exemplary embodiments of the invention, the reassignment of remote units between communication channels may be performed substantially without interrupting the flow of communication (data) between the AP and the remote unit being reassigned, to provide a smooth transition between communication channels, such that channel reassignment may be substantially transparent to users of the remote units.

According to exemplary embodiments of the present invention, the reassignment of a remote unit from one channel to another channel and the execution of such reassignment may be accomplished substantially without disrupting communication between the AP and the remote unit. For example, the AP need not send a disassociation request to the remote unit when it switches from one channel to another channel. Moreover, the AP need not re-authenticate communication with the remote unit upon transferring communication from one channel to another. It will be appreciated by those skilled in the art that the present invention is not limited in the respects above, and that numerous embodiments of the invention are possible. For example, other apparatus, systems and methods of switching a remote unit from one channel to another channel without requiring re-authentication are possible.

While the invention has been described with respect to a limited number of embodiments, it will be appreciated that many variations, modifications and other applications of the invention may be made. Embodiments of the present invention may include other apparatuses for performing the operations herein. Such apparatuses may integrate the elements discussed, or may comprise alternative components to carry out the same purpose. It will be appreciated by persons skilled in the art that the appended claims are intended to cover all such modifications and changes as fall within the true spirit of the invention.

What is claimed is:

1. An apparatus comprising a media access controller to control communication substantially simultaneously with a plurality of remote units over a plurality of channels.

2. The apparatus of claim 1, further comprising a plurality of baseband processors associated with said plurality of channels, respectively.

3. The apparatus of claim 2, comprising a processor to process data for transmission by said media access controller.

4. The apparatus of claim 2, comprising a processor to process data received from said media access controller.

5. A wireless device comprising:
a media access controller to control communication substantially simultaneously with a plurality of remote units over a plurality of channels; and
a plurality of omni-directional antennas operably connected to said media access controller to transmit data over said plurality of channels, respectively.

6. The wireless device of claim 5, comprising a plurality of baseband processors associated with said plurality of channels, respectively.

7. The wireless device of claim 6, comprising a processor to process data for transmission by said media access controller.

8. The wireless device of claim 7, comprising a processor to process data received from said media access controller.

9. A method comprising:
switching a remote unit in communication with a media access controller from a first operating channel to a second operating channel, wherein communication between said remote unit and said media access controller is substantially undisrupted.

10. The method of claim 9, comprising transmitting a channel switch request to said remote unit.

11. The method of claim 10, wherein transmitting a channel switch request comprises transmitting a parameter relating to a mode of communication between said media access controller and said remote unit.

12. The method of claim 10, wherein transmitting a channel switch request comprises transmitting a parameter relating to said second operating channel.

13. The method of claim 10, wherein transmitting a channel switch request comprises transmitting a parameter relating to a counter.

14. The method of claim 10, comprising receiving from said remote unit a communication responsive to said channel switch request.

15. The method of claim 14, wherein receiving said communication responsive to said channel switch request comprises receiving a positive reply.

16. The method of claim 14, wherein receiving said communication responsive to said channel switch request comprises receiving a negative reply.

17. The method of claim 14, wherein receiving said communication responsive to said channel switch request comprises receiving a request for a different channel.

18. The method of claim 9, wherein switching said remote unit comprises switching based on a parameter relating to a load of remote units communicating with said media access controller on at least one of said first and second channels.

19. The method of claim 18, wherein switching comprises switching communication between said remote unit and said media access controller from said first channel to said second channel if a load remote units communicating with said media access controller on said first channel is greater than a load of remote units communicating with said media access controller on said second channel.

20. The method of claim 9, wherein switching said remote unit comprises switching based on a parameter relating to deterioration in a signal transmitted between said media access controller and said remote unit.

21. A program storage device having instructions readable by a machine that when executed by the machine result in:
switching a remote unit in communication with a media access controller from a first operating channel to a second operating channel, wherein communication between said remote unit and said media access controller is substantially undisrupted.

22. The program storage device of claim 21, wherein said instructions result in transmitting a channel switch request to said remote unit.

23. The program storage device of claim 22, wherein said instructions result in transmitting a parameter relating to a mode of communication between said media access controller and said remote unit.

24. The program storage device of claim 22, wherein said instructions result in transmitting a parameter relating to said second operating channel.

25. The program storage device of claim 22, wherein said instructions result in transmitting a parameter relating to a counter.

26. The program storage device of claim 21, wherein said instructions result in switching based on a parameter related to a load of remote units communicating with said media access controller on at least one of said first and second channels.

27. The program storage device of claim 26, wherein said instructions result in switching communication between said remote unit and said media access controller from said first channel to said second channel if a load remote units communicating with said media access controller on said first channel is greater than a load of remote units communicating with said media access controller on said second channel.

28. The program storage device of claim 21, wherein said instructions result in switching based on a parameter relating to deterioration in a signal transmitted between said media access controller and said remote unit.

29. A system comprising:
an access point able to transmit data to a plurality of remote units on a plurality of operating channels; and
a plurality of remote units able to receive said data,
wherein said access point is able to switch one of said plurality of remote units from a first operating channel to a second operating channel substantially without disrupting communication between said access point and said remote unit.

30. The system of claim 29, wherein said access point comprises:
a media access controller; and
a plurality of transceivers operably connected to said media access controller to transmit data to said remote units.

31. The system of claim 30, wherein said access point comprises a processor to provide to said media access controller data for transmission to said remote units.

32. The system of claim 29, wherein said access point is able to switch one of said plurality of remote units from a first operating channel to a second operating channel based on a parameter related to a load of remote units communicating with said access point on at least one of said first and second channels.

33. The system of claim 29, wherein said access point is able to switch one of said plurality of remote units from a first operating channel to a second operating channel based on a parameter related to deterioration of a signal transmitted between said media access controller and said remote unit.
